(19) United States
(12) Patent Application Publication
(10) Pub. No.: US 2008/0095626 A1
(43) Pub. Date: Apr. 24, 2008

(54) Fan wheel and electric motor

(75) Inventors: Norbert Krogmeier, Bielefeld (DE); Klaus Konig, Oerlinghausen (DE)

Correspondence Address: BIRCH STEWART KOLASCH & BIRCH, PO BOX 747, FALLS CHURCH, VA, 22040-0747, US

(73) Assignee: HANNING ELEKTRO-WERKE GmbH & Co. KG, Oerlinghausen (DE)

(21) Appl. No.: 11/583,923

(22) Filed: Oct. 20, 2006

(51) Int. Cl. B64C 27/00

(52) U.S. Cl. 416/146 R

(57) ABSTRACT

This present invention relates to a fan wheel for an electric motor which fan wheel comprises fan vanes and a cylindrically arranged hub wherein said hub consists of a rigid fixing section for attachment to a drive shaft of the electric motor on the one hand and of a flexible section axially extending from said fixing section on the other hand and wherein the fan vanes are allocated to the flexible section.

This present invention relates to a fan wheel for an electric motor which wheel comprises fan vanes as well as a cylindrically arranged hub.

The invention also relates to an electric motor for a pump wherein a fan wheel is mounted on a drive shaft.

Prior known in the art are synchronous circulation pumps for evaporation coolers which pumps are operable by an electric motor and a fan wheel secured to the electric motor drive shaft. It has been found out, however, that undesirable hunting moments are generated, especially during the starting phase of the motor, which are transmitted to the entire pump system via said drive shaft. These undesirable vibrations are even increased by the fan wheel.

It is an object of this present invention, therefore, to improve a fan wheel or an electric motor, respectively, in such a way that pendulum oscillations generated by an electric motor and/or a fan wheel are reduced.

To achieve that object, the present invention is in conjunction with the preamble of Claim 1 characterized by the fact that a hub comprises a rigid fixing section adapted to be attached to the drive shaft of the electric motor on the one hand and a flexible section extending axially from said fixing section on the other hand, the fan vanes being allocated to said flexible section.

The fan wheel of this invention has an oscillation damping effect which results in significant noise reduction. The basic idea underlying the invention resides in that a hub of the fan wheel is subdivided into two axial sections having different material properties so that in terms of oscillation there is separation created between the fan wheel on the one hand and further components of a constructional unit (circulation pump) connected to the fan wheel on the other hand. Due to the fact that a rigid fixing section of the hub serving to attach the fan wheel to the drive shaft is arranged an axial distance away from a flexible hub section, said rigid fixing section is nothing better than just an axial extension of the fan wheel. The fan wheel components influencing the flow conditions are allocated to the flexible section such that the shape of the fan wheel in radial direction may essentially be the same. Due to the fact that the section carrying the flow influencing components such as fan vanes, for instance, is of a flexible configuration, it is possible to dampen shaft rotational oscillations and/or to prevent transmission thereof to the remainder of the pump system.

According to a preferred embodiment of the invention the flexible section of the hub is integrally connected to the fixing section thereof and it is only the fixing section of the hub that is connected to the shaft. Separation of the fan wheel from the shaft from an oscillation point of view is further enhanced due to an axial offset of the flow influencing components having a radial plane common with the flexible section.

A further improvement of the invention provides for the flexible section of the hub to be injection molded to the fixing section thereof in which case the flexible section is formed of an elastomeric material. The fixing section is preferably composed of a rigid polypropylene material. The fan wheel may be advantageously produced by two-component injection molding in one single step.

According to another improvement of the invention the fixing section of the hub is in the form of a cylindrical sleeve which via a reduced end portion is connected to an annular member with annular groove of the flexible section. The wall thickness of the reduced end portion is greater than the annular groove such that the flexible section of the hub is substantially not in contact with the shaft. This permits to improve the damping effect on the fan wheel even further.

The electric motor has the features disclosed in patent claim 12 to achieve its object.

Further advantages afforded by this present invention are evident from the further subclaims.

An exemplary embodiment of the present invention will now be explained with reference to the drawings in which:

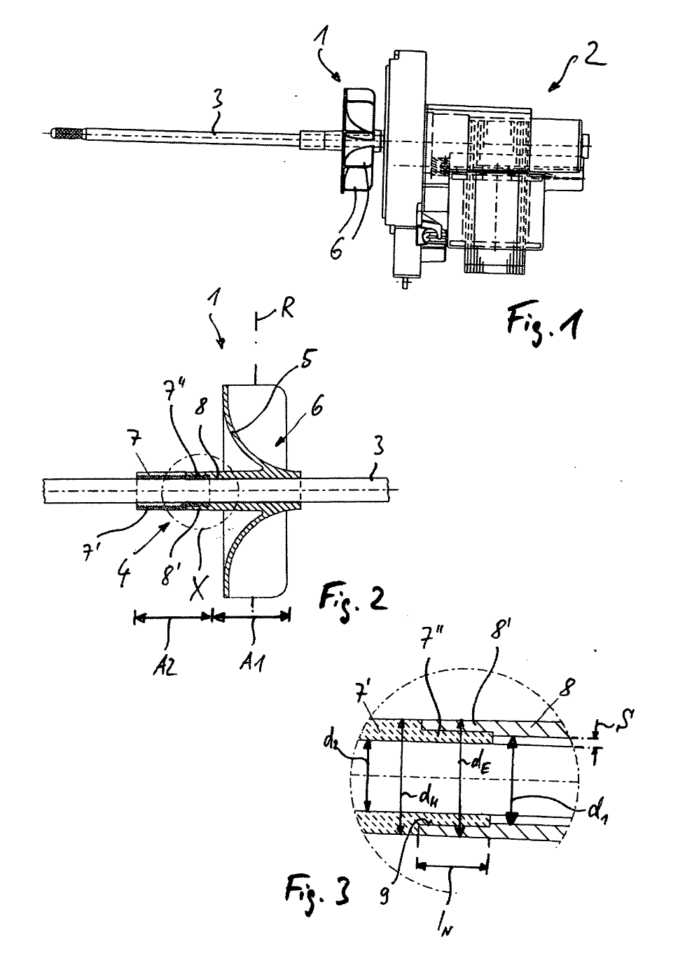

FIG. 1 is a side view of a circulation pump;

FIG. 2 is a longitudinal section through a fan wheel which is attached to the drive shaft of an electric motor; and

FIG. 3 is a larger-scale view of a detail X in FIG. 2.

A fan wheel 1 of this present invention may be employed for circulation pump systems of the type used in domestic appliances or in industrial production facilities.

FIG. 1 shows a synchronous circulation pump for evaporation coolers comprising an electric motor 2 with a drive shaft 3 for the fan wheel 1 to be mounted on.

The fan wheel 1 comprises a number of radially curved spokes 5 which extend from a hub 4 and which are each adjoined by fan vanes 6.

The hub 4 is provided in form of a hollow cylinder and composed of a rigid fixing section 7 and a flexible section 8 offset in axial direction. The flexible section 8 comprising the spokes 5 and the fan vanes 6 is disposed in a first axial portion A1 and the fixing section is arranged in a second axial portion A2 adjacent thereto. The flexible section 8 is integrally formed with the spokes and the fan vanes 6, respectively, and extends in a substantially common radial plane R.

The fixing section 7 of the hub 4 is made of a rigid/strong plastic material, preferably propylene, and secured to the drive shaft 3 in a press-fit mode.

The flexible section 8 of the hub together with the spokes 5 and the fan vanes 6 of the fan wheel 1 is formed of a flexible (oscillation damping) plastic material, preferably a thermoplastic elastomer.

The fixing section 7 of the hub 4 is provided in form of a cylindrical sleeve which is positively and/or integrally and/or frictionally fitted on the drive shaft 3. The shell surface of the fixing section 7 consists of a main portion 7′ and a reduced end portion 7″ which portions are in contact with the drive shaft 3 by their inside faces. The reduced end portion 7″ of the sleeve is integrally connected to an annular portion 8′ of the flexible section 8. Said annular portion 8′ of the flexible section 8 is injection molded to the end portion 7″ of the sleeve 7.

The fan wheel 1 is preferably produced by a two-component injection molding process comprising the steps of charging into a mold the plastic material mass to provide the sleeve 7 first and the plastic material mass to provide the flexible section 8 thereafter.

As will be seen more clearly from FIG. 3, an inside diameter d₁ of the flexible section 8 is larger than an inside diameter d₂ of the sleeve 7 and/or the outside diameter d₂ of the drive shaft 3. This way there is always an annular gap S between the flexible section 8 and the drive shaft 3 within the first axial portion A1. This separation of the fan wheel 1 from the drive shaft 3 permits to substantially damp or reduce the action of interfering pendulum oscillations.

The wall thickness of the end portion 711 of the sleeve 7 and that of the annular portion 81 of the flexible section 8 is selected such that the main portion 71 of the sleeve 7 and the flexible section 8′ have the same outside diameter d_{M} or d_{E}, respectively. This implies that the hub 4 has a continuous cylindrical outer surface extending along the first axial portion A1 and the second axial portion A2.

The annular portion 8′ of the flexible section 8 preferably has an inner annular groove 9 whose length 1_{N} predetermines the length of the reduced end portion 7″ of the sleeve 7. This permits to improve on the adhesive force in the junction areas between the sleeve 7 and the flexible section 8.

According to a not-shown embodiment of the present invention it is also possible to provide the fan wheel 1 with a fan rim to which the fan vanes are attached. The spokes are connected to said fan rim in that embodiment.

1. Fan wheel for an electric motor comprising fan vanes and a cylindrically arranged hub, characterized by the fact that the hub (4) has a rigid fixing section (7) for attachment to the drive shaft (3) of an electric motor (2) on the one hand and a flexible section (8) in axial extension of said fixing section (7) on the other hand, said fan vanes (6) being disposed within said flexible section (8).

2. Fan wheel as set forth in claim 1, characterized by the fact that the flexible section (8) of the hub (4) is integrally connected to the fixing section (7) thereof.

3. Fan wheel as set forth in claim 1, characterized by the fact that the flexible section (8) of the hub (4) is injection molded to the fixing section (7) thereof.

4. Fan wheel as set forth in claim 1, characterized by the fact that the hub (4) is produced by two-component injection molding wherein the fixing section (7) is formed of a propylene material and the flexible section (8) of an elastomeric material.

5. Fan wheel as set forth in claim 1, characterized by the fact that the fixing section (7) is provided in form of a cylindrical sleeve which is adapted to be positively and/or integrally and/or frictionally connected to the drive shaft (3) by one of its shell surfaces.

6. Fan wheel as set forth in claim 1, characterized by the fact that the sleeve (7) comprises a main portion (7′) and a reduced end portion (7″) wherein an annular portion (8′) of the flexible section (8) extends from an outside surface of the end portion (7″).

7. Fan wheel as set forth in claim 1, characterized by the fact that the inside diameter (d₁) of the flexible section (8) is larger than the inside diameter (d₂) of the sleeve (7) or larger than the outside diameter (d₂) of the drive shaft (3), respectively.

8. Fan wheel as set forth in claim 1, characterized by the fact that the annular portion (8′) of the flexible section (8) and the main portion (7′) of the sleeve (7) have the same outside diameter (d_{M}, d_{E}).

9. Fan wheel as set forth in claim 1, characterized by the fact that the flexible section comprises within the annular portion (8′) an inner annular groove (9) for the reduced end portion (7″) of the sleeve to extend in.

10. Fan wheel as set forth in claim 1, characterized by the fact that the length (1_{N}) of the annular groove (9) corresponds to the length of the end portion (7″) of the sleeve (7).

11. Fan wheel as set forth in claim 1, characterized by the fact that the fan vanes (6) and/or the fan spokes (5) and/or a fan rim are arranged to extend within a first axial portion (A1) of the fan wheel (1) on the one hand and that the fixing section (7) of the hub (4) extends within a second axial portion (A2) of said fan wheel (1) on the other hand.

12. Electric motor for a pump which motor comprises a fan wheel mounted on a drive shaft as set forth in claim 1.
